(19) United States
(12) Patent Application Publication
(10) Pub. No.: US 2013/0074088 A1
(43) Pub. Date: Mar. 21, 2013

(54) SCHEDULING AND MANAGEMENT OF COMPUTE TASKS WITH DIFFERENT EXECUTION PRIORITY LEVELS

(71) Applicants: Timothy John PURCELL, Provo, UT (US); Lacky V. Shah, Los Altos Hills, CA (US); Jerome F. Duluk, JR., Palo Alto, CA (US)

(72) Inventors: Timothy John PURCELL, Provo, UT (US); Lacky V. Shah, Los Altos Hills, CA (US); Jerome F. Duluk, JR., Palo Alto, CA (US)

(21) Appl. No.: 13/236,473

(22) Filed: Sep. 19, 2011

(51) Int. Cl. G06F 9/46

(52) U.S. Cl. 718/103

(57) ABSTRACT

One embodiment of the present invention sets forth a technique for dynamically scheduling and managing compute tasks with different execution priority levels. The scheduling circuitry organizes the compute tasks into groups based on priority levels. The compute tasks may then be selected for execution using different scheduling schemes, such as round-robin, priority, and partitioned priority. Each group is maintained as a linked list of pointers to compute tasks that are encoded as queue metadata (QMD) stored in memory. A QMD encapsulates the state needed to execute a compute task. When a task is selected for execution by the scheduling circuitry, the QMD is removed for a group and transferred to a table of active compute tasks. Compute tasks are then selected from the active task table for execution by a streaming multiprocessor.

### BACKGROUND OF THE INVENTION

1. Field of the Invention

The present invention generally relates to execution of compute tasks and more specifically to scheduling and management of compute tasks with different priority levels.

2. Description of the Related Art

Conventional scheduling of compute tasks for execution in multiple processor systems relies on an application program or driver to determine priorities for each of the compute tasks. During execution of the compute tasks, interaction between the driver and multiple processors that is needed to allow the driver to schedule the compute tasks may delay execution of the compute tasks.

Accordingly, what is needed in the art is a system and method for dynamically scheduling compute tasks for execution based on the processing resources and priorities of the available compute tasks. Importantly, the scheduling mechanism should not depend on or require software or driver interaction.

### SUMMARY OF THE INVENTION

A system and method for dynamically schedules and manages compute tasks with different execution priority levels. The scheduling circuitry organizes the compute tasks into groups based on priority levels. The compute tasks may then be selected for execution using different scheduling schemes, such as round-robin, priority, and partitioned priority. Each group is maintained as a linked list of pointers to compute tasks that are encoded as queue metadata (QMD) stored in memory. A QMD encapsulates the state needed to execute a compute task. When a task is selected for execution by the scheduling circuitry, the QMD is removed for a group and transferred to a table of active compute tasks. Compute tasks are then selected from the active task table for execution by a streaming multiprocessor.

Various embodiments of a method of the invention for scheduling compute tasks for execution include selecting a first compute task from a head of a linked list for a group of compute tasks at a first priority level of multiple priority levels and identifying a lowest priority level of active compute tasks that are scheduled for execution and stored in a task table. The first priority level is compared with the lowest priority level. When the first priority level is higher than the lowest priority level a second compute task having a priority at the lowest priority level that is stored in the task table is replaced with the first compute task.

Various embodiments of the invention include a system for scheduling compute tasks for execution. The system includes a memory that is configured to store queue metadata corresponding to the compute tasks, a work distribution unit that is configured to store active compute tasks that are scheduled for execution in a task table, and a task management unit. The task management unit is configured to select a first compute task from a head of a linked list for a group of compute tasks at a first priority level of multiple priority levels, identify a lowest priority level of the active compute tasks, compare the first priority level with the lowest priority level, determine that the first priority level is higher than the lowest priority level, and replace a second compute task having a priority at the lowest priority level that is stored in the task table with the first compute task.

The scheduling mechanism enables management of the compute tasks having different priority levels for execution. The scheduling circuitry maintains a pointer to a QMD in memory for each compute task so that compute tasks may be quickly selected for execution and the respective QMD is transferred to the active task table.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the invention;

FIG. 2 is a block diagram of a parallel processing subsystem for the computer system of FIG. 1, according to one embodiment of the invention;

FIG. 3 is a block diagram of the Task/Work Unit of FIG. 2, according to one embodiment of the invention;

FIG. 4A is a conceptual diagram of the contents of the scheduler table of FIG. 3, according to one embodiment of the invention;

FIGS. 4B, 4C, 4D, and 4E are conceptual diagrams of the contents of the scheduler table and the task table of FIG. 3 over time, according to one embodiment of the invention;

FIG. 5A illustrates a priority scheduling method for scheduling compute tasks with different execution priority levels, according to one embodiment of the invention;

FIG. 5B illustrates a partitioned priority scheduling method for scheduling compute tasks with different execution priority levels, according to one embodiment of the invention;

FIG. 6A is another block diagram of the Task/Work Unit of FIG. 3, according to one embodiment of the invention; and

FIG. 6B illustrates a method for loading an entry in the QMD cache, according to one embodiment of the invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

### System Overview

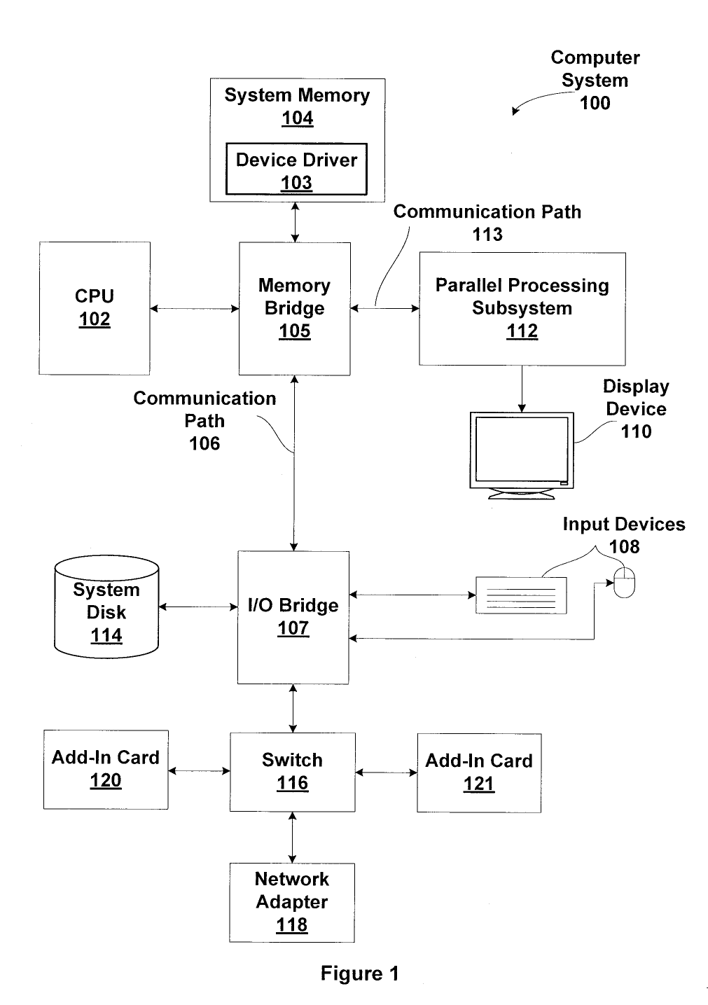

FIG. 1 is a block diagram illustrating a computer system 100 configured to implement one or more aspects of the present invention. Computer system 100 includes a central processing unit (CPU) 102 and a system memory 104 communicating via an interconnection path that may include a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via path 106 and memory bridge 105. A parallel processing subsystem 112 is coupled to memory bridge 105 via a bus or other communication path 113 (e.g., a PCI Express, Accelerated Graphics Port, or HyperTransport link); in one embodiment parallel processing subsystem 112 is a graphics subsystem that delivers pixels to a display device 110 (e.g., a conventional CRT or LCD based monitor). A system disk 114 is also connected to I/O bridge 107. A switch 116 provides connections between I/O bridge 107 and other components such as a network adapter 118 and various add-in cards 120 and 121. Other components (not explicitly shown), including USB or other port connections, CD drives, DVD drives, film recording devices, and the like, may also be connected to I/O bridge 107. Communication paths interconnecting the various components in FIG. 1 may be implemented using any suitable protocols, such as PCI (Peripheral Component Interconnect), PCI-Express, AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements, such as the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip. Large embodiments may include two or more CPUs 102 and two or more parallel processing systems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

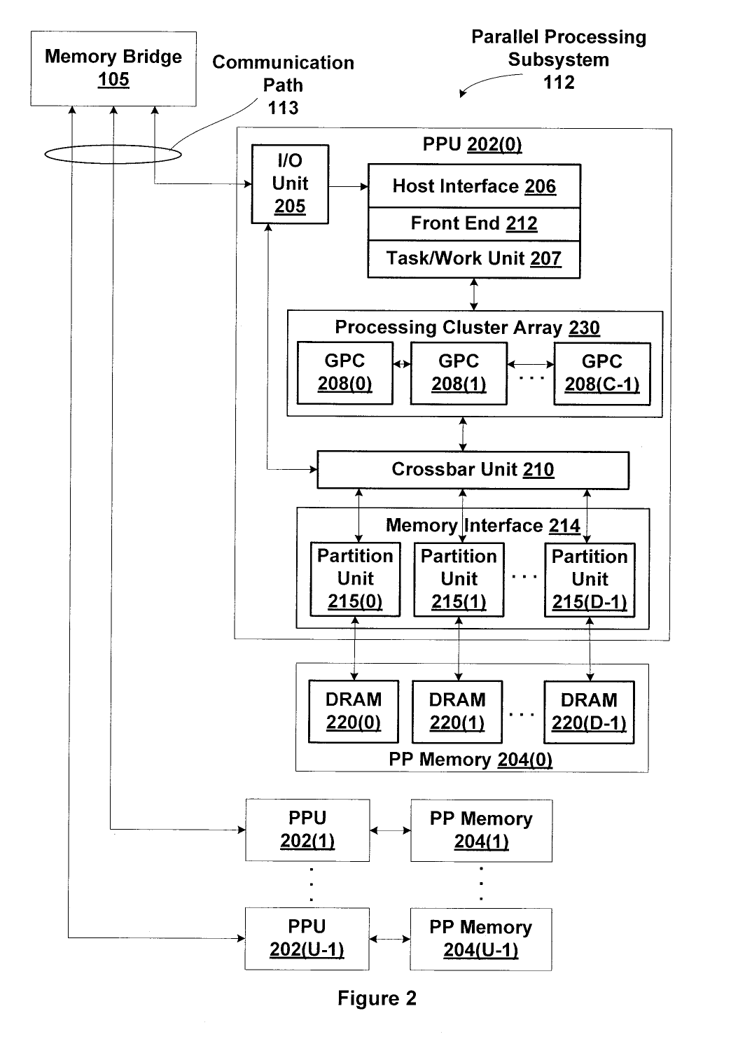

FIG. 2 illustrates a parallel processing subsystem 112, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), or memory devices, or in any other technically feasible fashion.

Referring again to FIG. 1, in some embodiments, some or all of PPUs 202 in parallel processing subsystem 112 are graphics processors with rendering pipelines that can be configured to perform various operations related to generating pixel data from graphics data supplied by CPU 102 and/or system memory 104 via memory bridge 105 and bus 113, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations. The PPUs may be identical or different, and each PPU may have its own dedicated parallel processing memory device(s) or no dedicated parallel processing memory device(s). One or more PPUs 202 may output data to display device 110 or each PPU 202 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a data structure (not explicitly shown in either FIG. 1 or FIG. 2) that may be located in system memory 104, parallel processing memory 204, or another storage location accessible to both CPU 102 and PPU 202. A pointer to each data structure is written to a pushbuffer to initiate processing of the stream of commands in the data structure. The PPU 202 reads command streams from one or more pushbuffers and then executes commands asynchronously relative to the operation of CPU 102. Execution priorities may be specified for each pushbuffer to control scheduling of the different pushbuffers.

Referring back now to FIG. 2B, each PPU 202 includes an I/O (input/output) unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/O bridge 107. In still other embodiments, some or all elements of PPU 202 may be integrated on a single chip with CPU 102.

In one embodiment, communication path 113 is a PCI-EXPRESS link, in which dedicated lanes are allocated to each PPU 202, as is known in the art. Other communication paths may also be used. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each pushbuffer and outputs the command stream stored in the pushbuffer to a front end 212.

Each PPU 202 advantageously implements a highly parallel processing architecture. As shown in detail, PPU 202(0) includes a processing cluster array 230 that includes a number C of general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary dependent on the workload arising for each type of program or computation.

GPCs 208 receive processing tasks to be executed from a work distribution unit within a task/work unit 207. The work distribution unit receives pointers to compute processing tasks that are encoded as queue metadata (QMD) and stored in memory. The pointers to QMDs are included in the command stream that is stored as a pushbuffer and received by the front end unit 212 from the host interface 206. Processing tasks that may be encoded as QMDs include indices of data to be processed, as well as state parameters and commands defining how the data is to be processed (e.g., what program is to be executed). The task/work unit 207 receives tasks from the front end 212 and ensures that GPCs 208 are configured to a valid state before the processing specified by each one of the QMDs is initiated. A priority may be specified for each QMD that is used to schedule execution of the processing task.

Memory interface 214 includes a number D of partition units 215 that are each directly coupled to a portion of parallel processing memory 204, where D≧1. As shown, the number of partition units 215 generally equals the number of DRAM 220. In other embodiments, the number of partition units 215 may not equal the number of memory devices. Persons skilled in the art will appreciate that DRAM 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Any one of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the embodiment shown in FIG. 2, crossbar unit 210 is directly connected with I/O unit 205. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory exclusively or almost exclusively. In UMA embodiments, a PPU 202 may be integrated into a bridge chip or processor chip or provided as a discrete chip with a high-speed link (e.g., PCI-EXPRESS) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

### Multiple Concurrent Task Scheduling

Multiple processing tasks may be executed concurrently on the GPCs 208 and a processing task may generate one or more “child” processing tasks during execution. The task/work unit 207 receives the tasks and dynamically schedules the processing tasks and child processing tasks for execution by the GPCs 208.

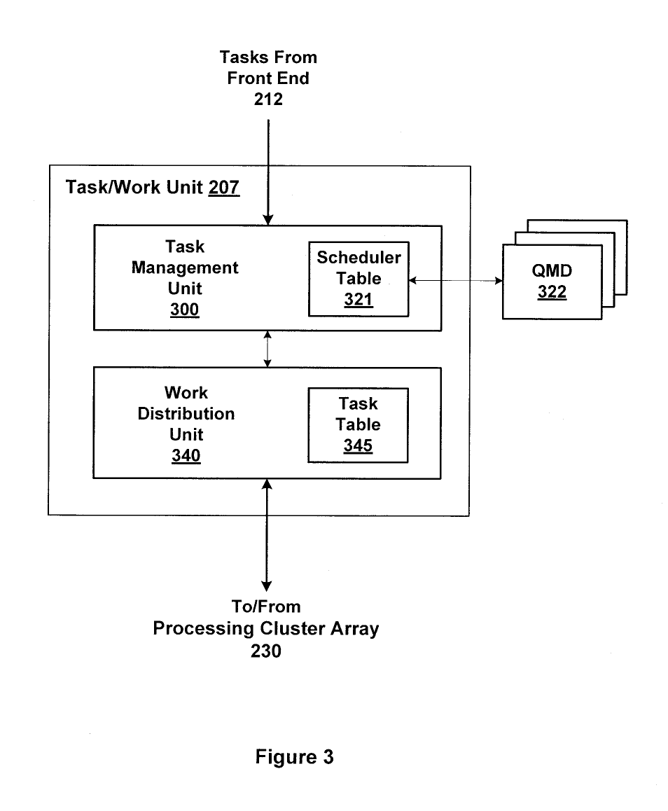

FIG. 3 is a block diagram of the task/work unit 207 of FIG. 2, according to one embodiment of the present invention. The task/work unit 207 includes a task management unit 300 and the work distribution unit 340. The task management unit 300 organizes tasks to be scheduled based on execution priority levels. For each priority level, the task management unit 300 stores a linked list of pointers to the QMDs 322 corresponding to the tasks in the scheduler table 321. The QMDs 322 may be stored in the PP memory 204 or system memory 104. The rate at which the task management unit 300 accepts tasks and stores the tasks in the scheduler table 321 is decoupled from the rate at which the task management unit 300 schedules tasks for execution, enabling the task management unit 300 to schedule tasks based on priority information or using other techniques.

The work distribution unit 340 includes a task table 345 with slots that may each be occupied by the QMD 322 for a task that is being executed. The task management unit 300 may schedule tasks for execution when there is a free slot in the task table 345. When there is not a free slot, a higher priority task that does not occupy a slot may evict a lower priority task that does occupy a slot. When a task is evicted, the task is stopped, and if execution the task is not complete, the task is added to a linked list in the scheduler table 321. When a child processing task is generated, the child task is added to a linked list in the scheduler table 321. A task is removed from a slot when the task is evicted.

Persons skilled in the art will understand that the architecture described in FIGS. 1, 2, and 3 in no way limits the scope of the present invention and that the techniques taught herein may be implemented on any properly configured processing unit, including, without limitation, one or more CPUs, one or more multi-core CPUs, one or more PPUs 202, one or more GPCs 208, one or more graphics or special purpose processing units, or the like, without departing the scope of the present invention.

### Task Scheduling and Management

The task management unit 300 manages compute tasks to be scheduled as an array of QMD groups that are stored in the scheduler table 321. A QMD group is a set of compute tasks with the same scheduling priority. The number of QMD groups, or priority levels, may be one or more. Within each QMD group, the compute tasks at the respective priority level are stored in a linked list. When compute tasks are received from the host interface 206 the task management unit 300 inserts the compute tasks into a QMD group. More specifically, a pointer to the QMD corresponding to the compute task is added to the tail of the linked list for that group unless a special QMD bit is set which causes the task to be added to the head of the linked list. Even though all tasks within a QMD group have the same scheduling priority level, the head of the QMD group linked list is the first compute task that is selected by the task management unit 300 and scheduled for execution. Thus, the compute task at the head of the linked list has a relatively higher priority compared with other compute tasks at the same priority level. Similarly, each successive compute task in the linked list at the same priority level as a lower priority relative to preceding compute tasks in the linked list. Therefore, the task management unit 300 is able to schedule the compute tasks within a QMD group in input order relative to one another (assuming none are specially marked to add to the head of the QMD group). Since the QMD group is specified as part of the QMD structure, the QMD group of a compute task cannot be changed while the compute task is being executed.

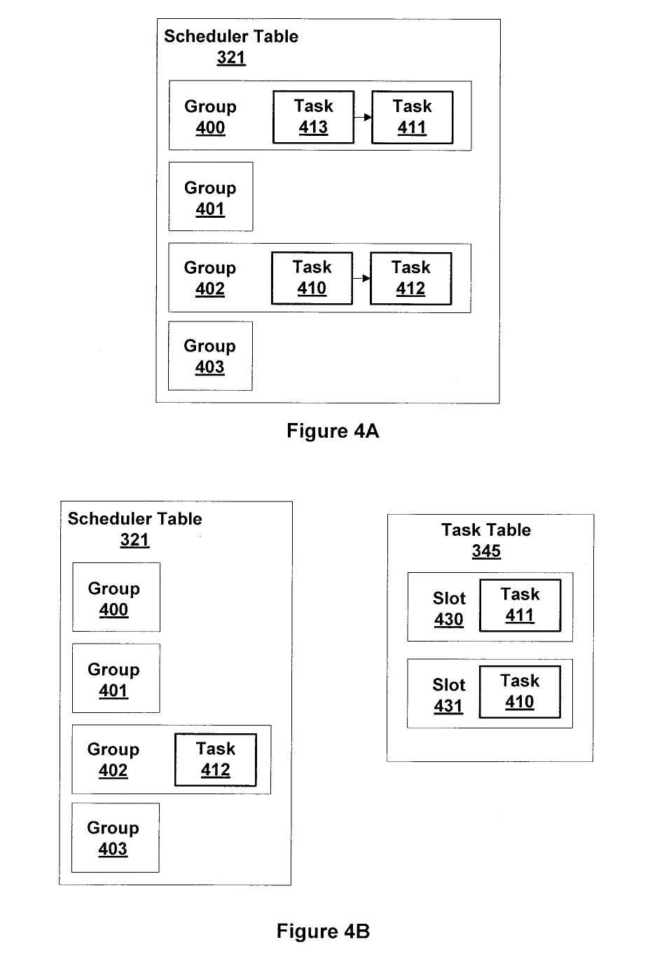

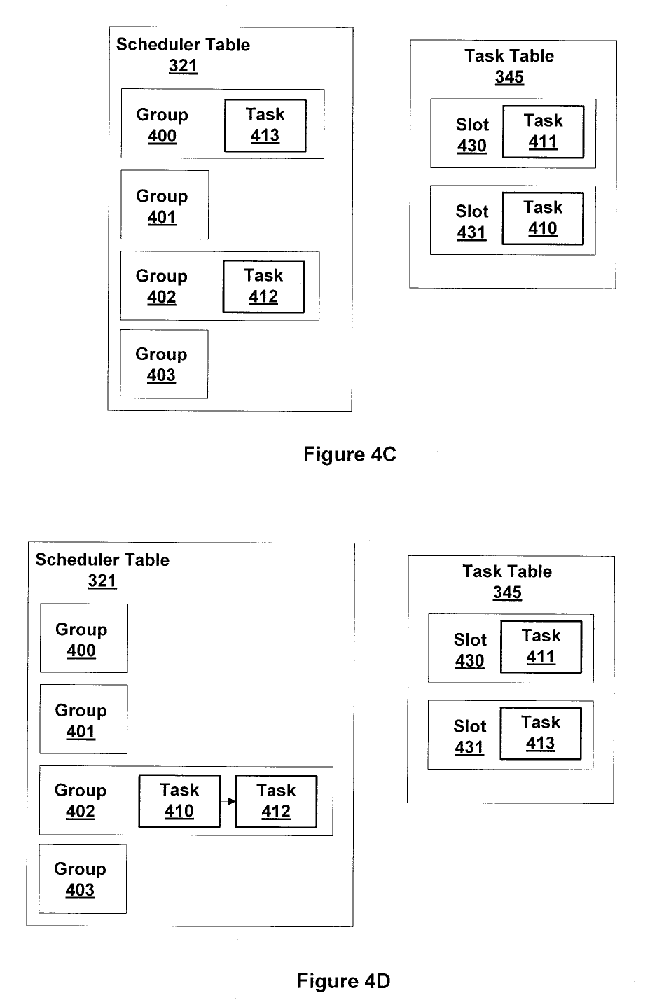

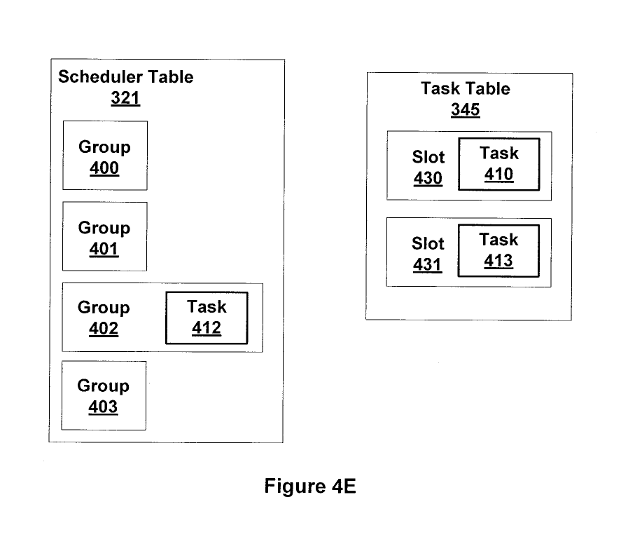

FIG. 4A is a conceptual diagram of the contents of the scheduler table 321 of FIG. 3 for an example compute task input sequence shown in TABLE 1, according to one embodiment of the invention.

TABLE 1

| Compute task | Priority level | Add-to-head flag |
|---|---|---|
| Task 410 | 2 | FALSE |
| Task 411 | 0 | FALSE |
| Task 412 | 2 | FALSE |
| Task 413 | 0 | TRUE |

The compute tasks are received in order, with task 410 first, task 411 second, task 412 third, and task 413 last. Priority level 2 is specified for task 410 and 412 and priority level 0 (highest priority) is specified for task 411 and 413. The add-to-head flag is set FALSE for each of tasks 410, 411, and 412, so when each of these tasks is received by the task management unit 300, the respective task is added to the tail of a linked list. The add-to-head flag is set to TRUE for task 413, so when task 413 is received by the task management unit 300, the respective task is added to the head of the linked list for tasks having a priority level of 0.

As shown in FIG. 4A, task 410 is added to a group 402 that is associated with priority level 2, and when task 412 is received, task 412 is added to the tail of the linked list for group 402. Task 411 is added to a group 400 that is associated with priority level 0, and when task 413 is received, task 413 is added to the head of the linked list for group 400. Therefore, task 413 is higher priority relative to task 411, even though both tasks are in group 400. Each QMD in a linked list stores a pointer to the next QMD in the respective linked list. Each group 400, 401, 402, and 403 stores a head pointer and a tail pointer for the linked list in the group and stores an empty bit. A QMD group having no tasks, such as groups 401 and 403, has a head pointer that equals the tail pointer and the empty bit is set TRUE. In group 400 the head pointer points to the task 413 and the tail pointer points to the task 411. In group 402 the head pointer points to the task 410 and the tail pointer points to the task 412.

The collection of compute tasks into groups based on priority levels prior to scheduling the compute tasks allows for a decoupling of the rate at which compute tasks are received by the task management unit 300 from the rate at which compute tasks are output to the work distribution unit 340 for execution. The task management unit 300 is generally able to accept compute tasks from one or more push buffers output by the host interface 206 at a faster rate than the compute tasks may be output for execution by the work distribution unit 340. The input from the different push buffers are independent streams, typically generated from different application programs. The task management unit 300 may be configured to buffer the compute tasks in the schedule table 321 and later select one or more compute tasks from the scheduler table 321 for output to the work distribution unit 340. By selecting the compute tasks after they are buffered, the task management unit may make the selection based on more information compared with selecting a compute task as compute tasks are received. For example, the task management unit 300 may buffer several low-priority tasks that are received before a high-priority task. The buffering enables the task management unit 300 to select the high-priority task for output before the low-priority tasks.

The task management unit 300 may perform selection to schedule the compute tasks using several different techniques: round-robin, priority, or partitioned priority scheduling. For each of the different scheduling techniques, when a compute task is selected to be scheduled, the selected compute task is removed from the group in which the selected compute task is stored. Regardless of the scheduling technique, the task management unit 300 is able to quickly select a compute task by selecting the first entry in the linked list of the appropriate group.

The simplest scheduling scheme is for the task management unit 300 to schedule the compute task at the head of each group (if a compute task exists in the group) and rotate through the groups in round-robin order. The input sequence as shown in TABLE 1 and stored in the scheduler table 321 shown in FIG. 4A would then result in compute tasks being scheduled as follows (from first to last): Task 413, Task 410, Task 411, and Task 412.

Another scheduling technique is priority scheduling that selects the compute tasks in strict priority order. The task management unit 300 selects a compute task from the highest priority group that has at least one compute task, starting at the head of the group. For the input sequence as shown in TABLE 1 and stored in the scheduler table 321 shown in FIG. 4A, would then result in compute tasks being scheduled as follows (from first to last): Task 413, Task 411, Task 410, and Task 412.

The task management unit 300 selects a compute task for execution. The selected task is only scheduled to run if there is an available slot in the task table 345 within the work distribution unit 340. An available slot is a slot that is either UNUSED (has no task associated with it) or has a lower priority than the selected task. An UNUSED slot is trivially available to accept a task. The task management unit 300 will consider a compute task stored in the task table 345 which has been reported as EMPTY (i.e., execution is complete) to be the lowest priority task stored in the task table 345. In other words, the task management unit 300 first tries to replace EMPTY compute tasks before replacing ACTIVE compute tasks of low priority that are stored in the task table.

If there is no UNUSED slot or slot storing a compute task reported as EMPTY in the task table 345, the task management unit 300 compares the lowest priority compute task that is scheduled, i.e., stored in the task table 345, with the compute task that the task management unit 300 has selected and is trying to schedule (e.g. the highest priority compute task that is not yet scheduled). If the lowest priority compute task stored in the task table 345 is of a lower priority than the selected compute task that the task management unit 300 is trying to schedule, then execution of the lower priority compute task stored in the task table 345 is stopped and the higher priority task is scheduled. More specifically, the higher priority compute task is transferred from the scheduler table 321 to the task table 345 and the lower priority compute task may be transferred from the task table 345 back to the scheduler table 321. If two compute tasks stored in the task table 345 have the same priority, the lower priority is the compute task that was most recently transferred into the task table 345.

When a scheduled compute task stored in the task table 345 is replaced by a higher priority task from the scheduler table 321 by the task management unit 300, execution of the scheduled compute task may not be complete. If execution of the scheduled compute task is not complete, the scheduled compute task is stopped and then re-added to the head of the group in the scheduler table 321 that corresponds to the priority level of the scheduled (now stopped) compute task. In this way, stopped compute tasks are considered for scheduling just as though the stopped compute task were a new compute task. When rescheduled, the stopped compute task begins executing where the stopped compute task left off.

FIGS. 4B through 4E are conceptual diagrams of the contents of the scheduler table 321 and the task table 345 of FIG. 3 over time, according to one embodiment of the invention. The task management unit 300 receives the input sequence shown in TABLE 1 and the task management unit 300 is configured to perform priority scheduling. However, task 413 is received following a long pause and the task table 345 is configured to store only two compute tasks to better illustrate priority replacement.

FIG. 4B is a conceptual diagram of the contents of the scheduler table 321 and the task table 345 of FIG. 3 after tasks 410, 411, and 412 are received by the task management unit 300, stored in the scheduler table 321, and then compute tasks 410 and 411 are selected and transferred to the task table 345. The compute task 411 is selected first (assuming there is not a long pause between when compute tasks 410 and 411 are received) and stored in the slot 410. The compute task 410, being lower priority than compute task 411 and higher priority compared with compute task 412 due to being first in the linked list for the group 402, is selected second and stored in the slot 431. The compute task 412 remains at the head of the linked list stored in group 402 of the scheduler table 321.

FIG. 4C is a conceptual diagram of the contents of the scheduler table 321 and the task table 345 of FIG. 3 when the compute task 413 is received by the task management unit 300, according to one embodiment of the invention. The compute task 413 is stored at the head of the linked list for the group 400.

FIG. 4D is a conceptual diagram of the contents of the scheduler table 321 and the task table 345 of FIG. 3 when the compute task 413 is scheduled using the priority scheduling technique, according to one embodiment of the invention. The task management unit 300 selects the highest priority compute task in the scheduler table 321, the compute task 413. Because slots 430 and 431 are both occupied with ACTIVE compute tasks, the task management unit 300 compares the priority of the compute task 413 with the priority of the lowest priority compute task stored in the task table 345, namely, task 410. Task 410 is priority level 2, corresponding to the group 402. Therefore, task 410 is a lower priority compared with task 413 and task 413 replaces task 410 in slot 431 of the task table 345. Task 410 is transferred from the task table 345 to the scheduler table 321 and is stored at the head of the inked list for the group 402.

FIG. 4E is a conceptual diagram of the contents of the scheduler table 321 and the task table 345 of FIG. 3 after execution of the task 411 is complete, according to one embodiment of the invention. When execution of the task 411 is complete the slot 430 is marked as EMPTY. The task management unit 300 then selects the highest priority task in the scheduler table 321 to transfer to the task table 345. The task 410 is selected and transferred from the head of the linked list in group 402 of the scheduler table 321 to the slot 430 in the task table 345. The task 410 is removed from the head of the linked list and task 412 becomes the head of the linked list for the group 402.

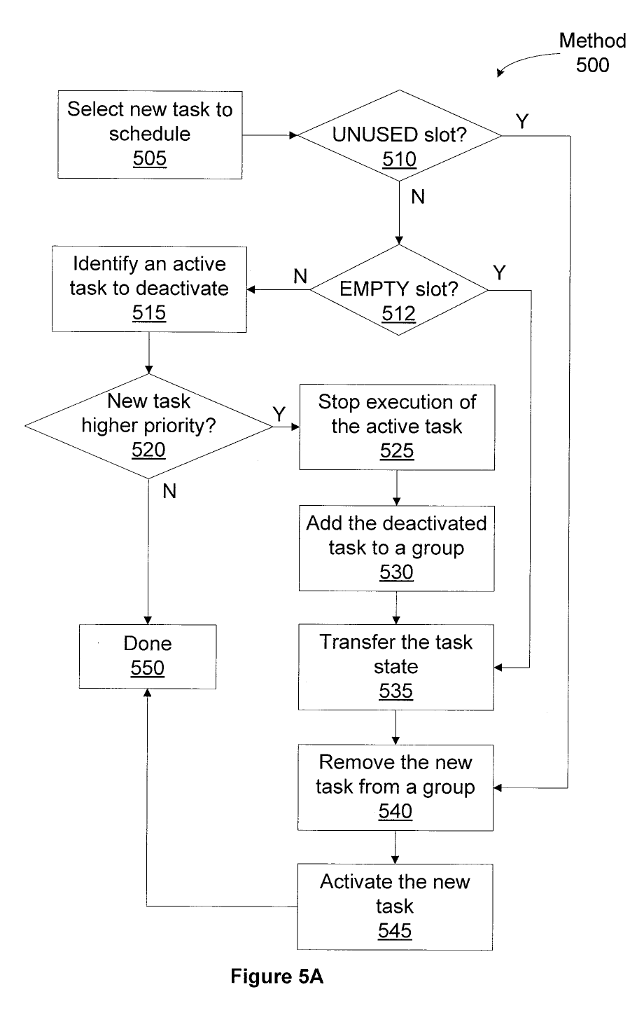

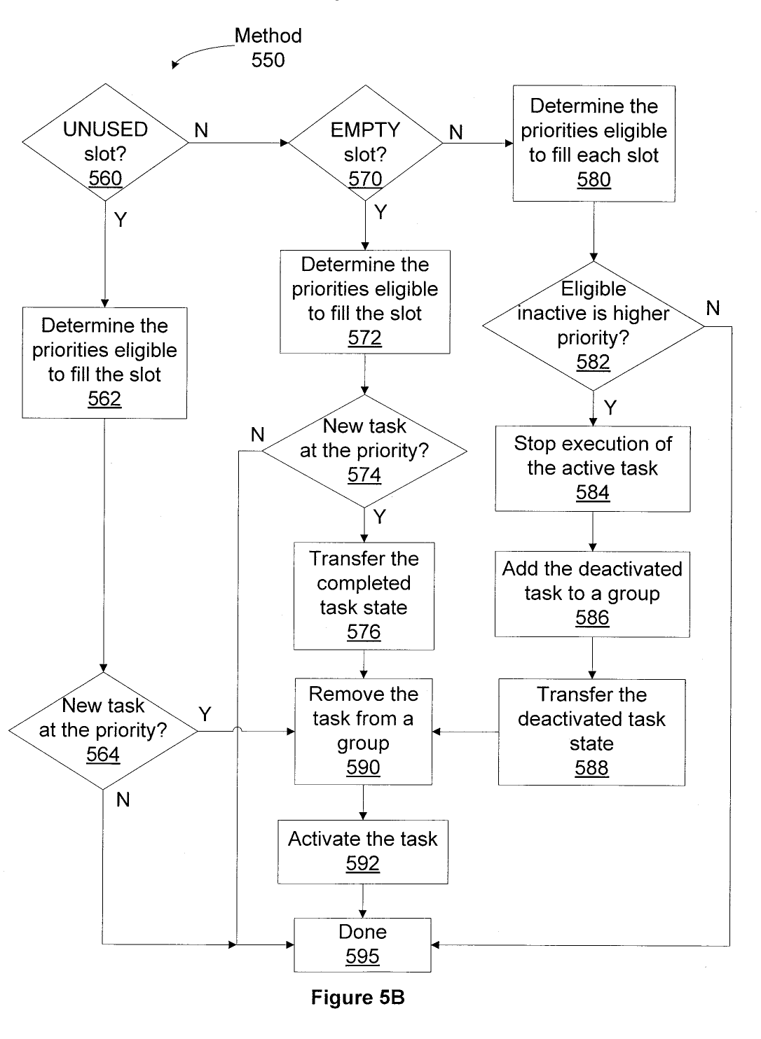

FIG. 5A illustrates a flowchart of the priority scheduling method 500 for scheduling compute tasks with different execution priority levels, according to one embodiment of the invention. Although the method steps are described in conjunction with the systems of FIGS. 1, 2, and 3, persons skilled in the art will understand that any system configured to perform the method steps, in any order, is within the scope of the inventions.

At step 505, the task management unit 300 selects a new compute task to schedule. The new compute task that is selected is the highest priority compute task stored in the scheduler table 321. At step 510, the task management unit 300 determines if there is an UNUSED slot in the task table 345. A slot that is UNUSED may be used directly for a new task. A slot that stores a completed task is marked as EMPTY. If, at step 510, an UNUSED slot is available, then the task management unit 300 proceeds to step 540 and removes the new compute task from the linked list in the group where the new compute task is stored in the scheduler table 321. Otherwise, at step 512, the task management unit 300 determines if there is an EMPTY slot in the task table 345. If, at step 512, an EMPTY slot is available, then the task management unit 300 proceeds to step 535 and the state of the identified completed task that will be replaced is transferred to the task management unit 300. Transferring the state needed for execution of the identified active task deallocates the EMPTY slot, so that the slot is then UNUSED. If, at step 512 an EMPTY slot is not available, then, at step 515 the task management unit 300 identifies an active task stored in the task table 345 to deactivate. More specifically, the task management unit 300 identifies the lowest priority compute task stored in the task table 345.

At step 520, the task management unit 300 determines if the new task is higher priority than the lowest priority active task, and, if not, then at step 550 the scheduling process is done. Otherwise, at step 525 the task management unit 300 instructs the work distribution unit 340 to stop execution of the identified active task that will be replaced. At step 530 the deactivated task is added to a group in the scheduler table 321 that stores a linked list of compute tasks at the same priority level as the deactivated task. At step 535 the state needed for execution of the identified active task that will be replaced is transferred to the task management unit 300. A portion of the state for the deactivated task may be stored within the task management unit 300 and/or a portion of the state for the deactivated task may be stored to the QMD 322 corresponding to the deactivated task.

At step 540 the new task is removed from the linked list in a group stored in the scheduler table 321. Note that the new task and the deactivated task cannot be at the same priority level (unless the deactivated task was EMPTY). At step 545 the new task is activated when the new task is transferred from the task management unit 300 and stored in a slot of the task table 345 in the work distribution unit 340. One or more activated tasks stored in the task table 345 are executing concurrently. The number of tasks which are executing may depend on the computational workload presented by one or more of the tasks occupying slots in the task table 345. At step 550 the scheduling process is done.

Another task scheduling technique, partitioned priority scheduling, is similar to priority scheduling. The key difference is that each slot in the task table 345 has a mask specifying which groups or priority levels can occupy the slot. In this way, some slots can be partitioned across one or more groups, allowing low-priority tasks to run concurrently with higher priority tasks—even when high priority tasks remain waiting to be scheduled.

FIG. 5B illustrates a flowchart of a partitioned priority scheduling method for scheduling compute tasks with different execution priority levels, according to one embodiment of the invention. Although the method steps are described in conjunction with the systems of FIGS. 1, 2, and 3, persons skilled in the art will understand that any system configured to perform the method steps, in any order, is within the scope of the inventions.

At step 560 the task management unit 300 determines if an UNUSED slot is available in the task table 345. If, so, then at step 562 the task management unit 300 determines the priorities of tasks eligible to fill the available slot. At step 564 the task management unit 300 then determines if any of the inactive tasks stored in the scheduler table 321 are an eligible priority for the UNUSED slot in the task table 345. If none of the inactive tasks stored in the scheduler table 321 are eligible, then at step 595 the scheduling process is done. If there is an eligible task, the task management unit 300 proceeds to step 590.

If at step 560 the task management unit 300 determines there is not an UNUSED slot in the task table 345, then at step 570 the task management unit 300 determines if an EMPTY slot is available in the task table 345. If so, at step 572 the task management unit 300 determines the priorities eligible to fill the slot in the task table 345. At step 574 the task management unit 300 then determines if any of the inactive tasks stored in the scheduler table 321 are an eligible priority for the EMPTY slot in the task table 345. If not, then at step 595 the scheduling process is done. If there is an eligible task, at step 576 the state of the identified completed task that will be replaced is transferred to the task management unit 300 before the task management unit 300 proceeds to step 590. A portion of the state for the completed task may be stored within the task management unit 300 and/or a portion of the state for the completed task may be stored to the QMD 322 corresponding to the completed task.

If, at step 570, an EMPTY slot is not available, then at step 580 the task management unit 300 determines the priorities eligible to fill one or more of the slots in the task table 345. At step 582 the task management unit 300 then determines if any of the inactive tasks stored in the scheduler table 321 are an eligible priority for one of the slots in the task table 345 and a higher priority than an active task occupying a slot in the task table 345. If none of the inactive tasks stored in the scheduler table 321 are at an eligible priority that is higher than an active task, then at step 595 the scheduling process is done. Otherwise, at step 584 the task management unit 300 stops execution of the active task that will be evicted from the task table 345 and replaced with higher priority inactive task. At step 586 the deactivated task is added to the respective group in the scheduler table 321 that stores a linked list of compute tasks at the same priority level as the deactivated task. At step 588 the state needed for execution of the identified active task that will be replaced is transferred to the task management unit 300 before the task management unit 300 proceeds to step 590. A portion of the state for the deactivated task may be stored within the task management unit 300 and/or a portion of the state for the deactivated task may be stored to the QMD 322 corresponding to the deactivated task.

When more than one priority level is eligible to fill an available slot in all the previously described cases, the task management unit 300 first looks for a task in the highest priority level that is eligible before looking at lower priority levels that are also eligible to fill the available slot.

At step 590 the task is removed from the group that is at an eligible priority level. At step 592 the task management unit 300 activates the task by transferring the task to the work distribution unit 340 that stores the task in the available slot of the task table 345. At step 595 the scheduling process is done.

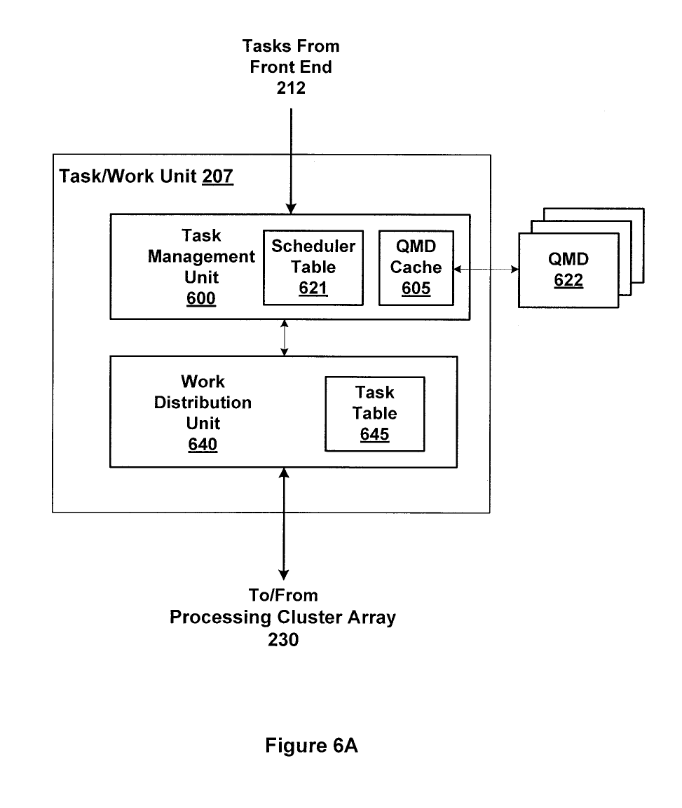

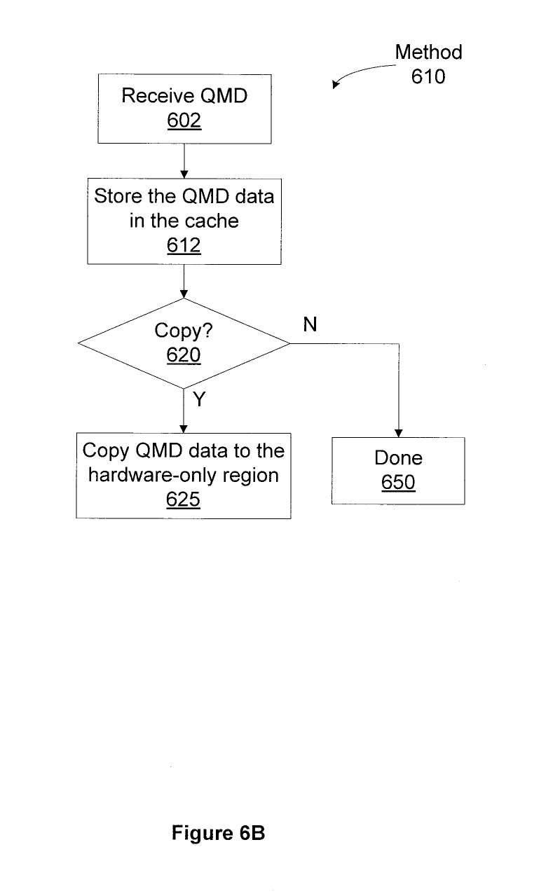

FIG. 6A is another block diagram of the task/work unit 207 of FIG. 3, according to one embodiment of the invention. The task/work unit 207 includes a task management unit 300 and a work distribution unit 640 that perform similar functions as the task management unit 300 and the work distribution unit 340. The task management unit 600 includes a scheduler table 621 and a QMD cache 605. The QMD cache 605 stores one or more QMDs 622. The work distribution unit 640 includes a task table 645.

Each QMD 622 may be a large structure, e.g., 256 Bytes or more, that is stored in PP memory 204. Due to the large size, the QMDs 622 are expensive to access in terms of bandwidth. Therefore, the QMD cache 605 stores only the (relatively small) portion of the QMD 622 that is needed by the task management unit 600 for scheduling. The remainder of the QMD 622 may be fetched from PP memory 204 when the task is scheduled, i.e., transferred to the work distribution unit 640.

The QMDs 622 are written under software control, and, when a compute task completes execution, the QMD associated with the completed compute task may be recycled to store information for a different compute task. Because the QMD may be stored in the QMD cache 605, the entries storing information for the completed compute task should be flushed from the QMD cache 605. The flushing operation is complicated because the writing of the information for the new compute task is decoupled from a write-back of information stored in the QMD cache 605 to the QMD 622 resulting from the flush. In particular, the information for the new task is written to the QMD 622 and then the QMD 622 is output to the front end 212 as part of a push buffer. Thus, the software does not receive a confirmation that the cache has been flushed, so that writing of the QMD 622 can be delayed. Because the cache write-back may overwrite information stored in the QMD 622 for the new task, a “hardware-only” portion of each QMD 622 is set aside for access only by the task management unit 600. The remainder of the QMD 622 may be accessed by software and the task management unit 600. The portion of the QMD 622 that can be accessed by software is typically filled by software to initiate a task. The QMD 622 is then accessed by the task management unit 600 and other processing units in the GPC 208 during scheduling and execution of the task. When information for a new compute task is written to a QMD 622, the command launching the QMD 622 may specify whether to copy bits into the hardware-only portion of the QMD 622 the first time the QMD 622 is loaded into the QMD cache 605. This ensures that the QMD 622 will correctly only store information for the new compute task since any information for the completed compute task would have only been stored in the hardware-only portion of the QMD.

FIG. 6B illustrates a flowchart for a method for loading an entry in the QMD cache 605, according to one embodiment of the invention. Although the method steps are described in conjunction with the systems of FIGS. 1, 2, 3, and 6A, persons skilled in the art will understand that any system configured to perform the method steps, in any order, is within the scope of the inventions.

At step 602 an entry in the QMD cache 605 is identified to be loaded with information stored in a QMD 622. The entry may be identified in response to a cache miss. At step 612 the task management unit 600 stores the QMD information in the cache entry. At step 620 the task management unit 600 determines if the command launching the QMD 622 specifies copying bits into the hardware-only portion of the QMD 622, and, if not, then at step 650 the filling of the entry in the QMD cache 605 is done. Otherwise, at step 625, the task management unit 600 copies the bits from the portion of the QMD 622 that is not hardware-only to the portion of the entry storing the hardware-only portion of the QMD 622. Copying the bits from the portion of the QMD 622 that is not hardware-only to the portion of the entry storing the hardware-only portion of the QMD 622 overwrites data stored for the executed compute task with data for the new compute task.

The scheduling mechanism enables management of the compute tasks having different priority levels for execution. The scheduling circuitry maintains separate linked lists for each priority level. The linked lists include pointers to QMDs 322 or 622 in memory for each compute task that has been received and not scheduled so that compute tasks may be quickly selected for scheduling. Selected compute tasks have their respective QMD 322 or 622 transferred to the task table 345 for execution.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense. the invention claimed is:

1. A method of scheduling compute tasks for execution, the method comprising:
selecting a first compute task from a head of a linked list for a group of compute tasks at a first priority level of multiple priority levels;
identifying a lowest priority level of active compute tasks that are scheduled for execution and stored in a task table;
comparing the first priority level with the lowest priority level;
determining that the first priority level is higher than the lowest priority level; and
replacing a second compute task having a priority at the lowest priority level that is stored in the task table with the first compute task.

2. The method of claim 1, further comprising:
receiving the first compute task; and
inserting the first compute task into the linked list stored for the group of compute tasks at the first priority level.

3. The method of claim 2, wherein the first compute task is inserted at a head of the linked list based on a flag provided with the first compute task.

4. The method of claim 2, wherein the first compute task is inserted at a tail of the linked list based on a flag provided with the first compute task.

5. The method of claim 2, further comprising:
reading first queue metadata corresponding to the first compute task from memory; and
storing the first queue metadata in an entry of the cache.

6. The method of claim 5, further comprising copying a first portion of the first queue metadata to a portion of the entry to overwrite data for the executed computed task.

7. The method of claim 1, wherein the replacing comprises:
stopping execution of the second compute task; and
inserting the second compute task into a head of a second linked list for a group of compute tasks at the lowest priority level.

8. The method of claim 1, wherein the replacing comprises storing state for the second compute task when execution of the second compute task is not complete.

9. The method of claim 1, wherein the replacing comprises removing the first compute task from the linked list for the group of compute tasks at the first priority level.

10. A system for scheduling compute tasks for execution, the system comprising:
a memory that is configured to store queue metadata corresponding to the compute tasks;
a work distribution unit that is configured to store active compute tasks that are scheduled for execution in a task table; and
a task management unit that is configured to:
select a first compute task from a head of a linked list for a group of compute tasks at a first priority level of multiple priority levels;
identify a lowest priority level of the active compute tasks;
compare the first priority level with the lowest priority level;
determine that the first priority level is higher than the lowest priority level; and
replace a second compute task having a priority at the lowest priority level that is stored in the task table with the first compute task.

11. The system of claim 10, wherein the task management unit is further configured to:
receive the first compute task; and
insert the first compute task into the linked list stored for the group of compute tasks at the first priority level.

12. The system of claim 11, wherein the first compute task is inserted at a head of the linked list based on a flag provided with the first compute task.

13. The system of claim 11, wherein the first compute task is inserted at a tail of the linked list based on a flag provided with the first compute task.

14. The system of claim 11, wherein the task management unit comprises a cache configured to store a portion of the queue metadata and the task management unit is further configured to:
read first queue metadata corresponding to the first compute task from the memory; and
store the first queue metadata in the entry of the cache.

15. The system of claim 14, wherein the task management unit is further configured to;
copy a first portion of the first queue metadata to a portion of the entry to overwrite data for the executed computed task.

16. The system of claim 10, wherein the replacing comprises:
stopping execution of the second compute task; and
inserting the second compute task into a head of a second linked list for a group of compute tasks at the lowest priority level.

17. The system of claim 10, wherein the replacing comprises storing state for the second compute task when execution of the second compute task is not complete.

18. The system of claim 10, wherein the replacing comprises removing the first compute task from the linked list for the group of compute tasks at the first priority level.

19. A method of scheduling compute tasks for execution, the method comprising:
identifying a first priority level of a first compute task that is stored in a task table and has completed execution;
selecting a second compute task from a head of a linked list for a first group of compute tasks at the first priority level of multiple priority levels;
storing the second compute task in a slot of a task table to replace the second compute task; and
removing the second compute task from the linked list for the first group of compute tasks.

20. The method of claim 19, wherein a linked list for a second group includes compute tasks at a second priority level that is higher priority compared with the first priority level.
